(19) United States
(12) Patent Application Publication
(10) Pub. No.: US 2017/0098227 A1
(43) Pub. Date: Apr. 6, 2017

(54) REAL-TIME CUSTOMER FEEDBACK AT POINT-OF-SALE

(71) Applicant: Andrew Geoffrey Cook, Weltevreden Park (ZA)

(72) Inventor: Andrew Geoffrey Cook, Weltevreden Park (ZA)

(21) Appl. No.: 14/875,702

(22) Filed: Oct. 6, 2015

(51) Int. Cl. G06Q 30/02

(52) U.S. Cl. CPC G06Q 30/0203

(57) ABSTRACT

A system for collecting and acting upon user feedback in real-time, comprising a feedback management server that produces and send feedback prompts to clients via a network and receives feedback responses from clients via a network, and an integration server that facilitates two-way communication via a network, and a method for collecting and acting upon user feedback in real-time.

### CROSS-REFERENCE TO RELATED APPLICATIONS

None.

### BACKGROUND OF THE INVENTION

Field of the Art

The disclosure relates to the field of retail sales, and more particularly to the field of collecting user feedback in real-time on a per-transaction basis.

Discussion of the State of the Art

In the art of retail sales, customer feedback is often considered vital to a successful retail storefront. Customers are often asked for their ZIP code or other metrics at a retail checkout in person, or to provide more detailed feedback when shopping virtually (for example, a star-rating system or a detailed text-based review). These feedback types are important for driving the business in terms of determining weak points or in what areas to focus for further training or improvement, and may be invaluable in evolving a particular retail establishment over time.

However, collecting and reacting to feedback in this manner necessarily involves a time delay. Feedback is collected, oftentimes well after a transaction is completed, and a customer may be focused on other things by that time or no longer be acutely aware of the nature of the particular transaction they're rating (as is common with delayed survey-based feedback, common in the art). Additionally, it takes time for management to react to this feedback as they must receive, review, and then act upon it in turn, all of which is further delayed when using survey-based feedback common in the art.

What is needed, is a means to collect and act upon feedback in real-time, on a per-transaction basis so that individual consumers may be responded to immediately upon the close of a transaction. This may be used to increase feedback quality and quantity, as customers are encouraged to provide more detailed and relevant feedback immediately regarding their most recent transaction, as well as to drive revenue as management will be empowered to better and more immediately respond to customers.

### SUMMARY OF THE INVENTION

Accordingly, the inventor has conceived and reduced to practice, in a preferred embodiment of the invention, a system and method for collecting and acting upon user feedback in real-time, on a per-transaction basis.

According to a preferred embodiment of the invention, a system for collecting and acting upon user feedback in real-time, comprising a feedback management server comprising at least a plurality of programming instructions stored in a memory and operating on a processor of a computing device and configured to provide at least a plurality of feedback prompts to an integration server, and configured to receive at least a feedback response from an integration server; and an integration server comprising at least a plurality of programming instructions stored in a memory and operating on a processor of a network-connected computing device and configured to operate a plurality of communication adapters, the configuration adapters each being configured to facilitate two-way communication with a plurality of clients, the clients each comprising at least a network-connected software application or hardware device, and configured to receive at least a plurality of transaction-specific information from at least a portion of the clients, and configured to transmit at least a plurality of feedback requests to at least a portion of the clients, the feedback prompts being based at least in part on at least a portion of the transaction-specific information, and configured to receive at least a plurality of feedback responses from at least a portion of the plurality of clients, and configured to transmit at least a portion of the plurality of feedback responses to a feedback management server, is disclosed.

According to another preferred embodiment of the invention, a method for collecting and acting upon user feedback in real-time, comprising the steps of providing, via a feedback management server comprising at least a plurality of programming instructions stored in a memory and operating on a processor of a computing device and configured to provide at least a plurality of feedback requests to an integration server, and configured to receive at least a feedback response from an integration server, a plurality of feedback requests to an integration server; transmitting, via an integration server comprising at least a plurality of programming instructions stored in a memory and operating on a processor of a network-connected computing device and configured to operate a plurality of communication adapters, the configuration adapters each being configured to facilitate two-way communication with a plurality of clients, the clients each comprising at least a network-connected software application or hardware device, and configured to transmit at least a plurality of feedback requests to at least a portion of the clients, and configured to receive at least a feedback response from at least one of the plurality of clients, and configured to transmit at least the feedback response to a feedback management server, a plurality of feedback requests to a plurality of clients via a network; receiving at least a plurality of feedback responses from at least a portion of the plurality of clients; and storing at least a portion of the plurality of feedback responses for future reference, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary system for collecting and acting upon user feedback in real-time, according to a preferred embodiment of the invention.

FIG. 6 is a block diagram illustrating an exemplary system for collecting and acting upon user feedback in real-time, utilizing a cloud-based distributed arrangement according to an embodiment.

FIG. 7 is a flow diagram illustrating an exemplary method for collecting and acting upon user feedback in real-time, according to a preferred embodiment of the invention.

### DETAILED DESCRIPTION

The inventor has conceived, and reduced to practice, in a preferred embodiment of the invention, a system and method for collecting and acting upon user feedback in real-time, on a per-transaction basis.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

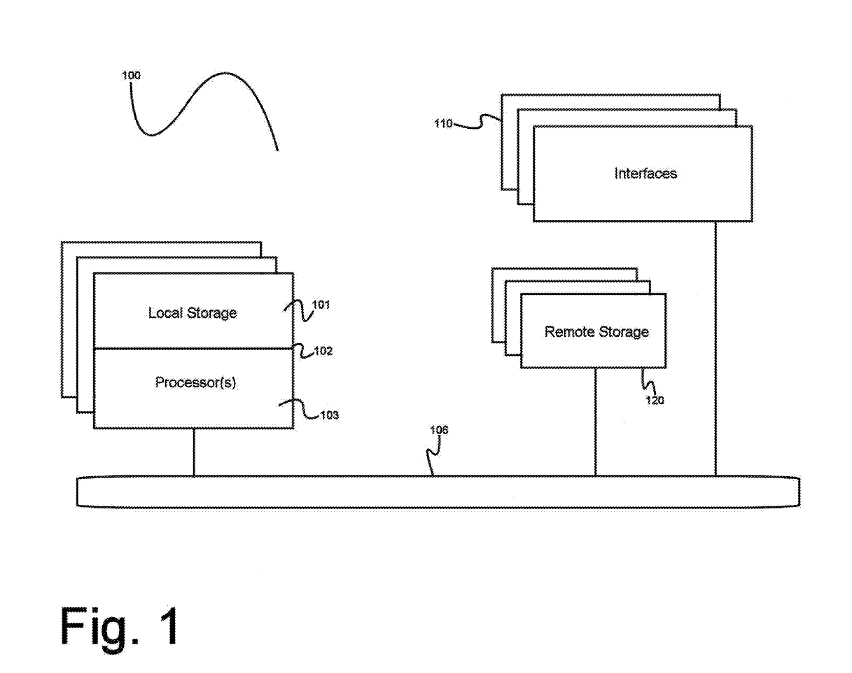

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote storage 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

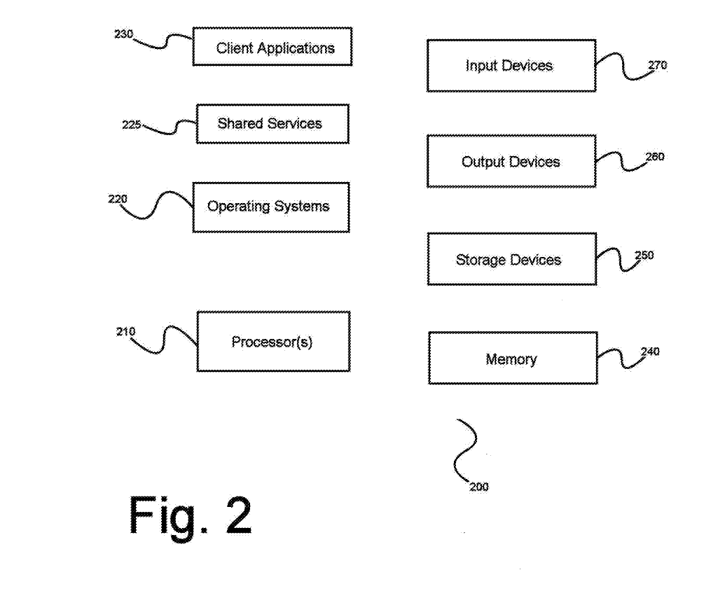

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

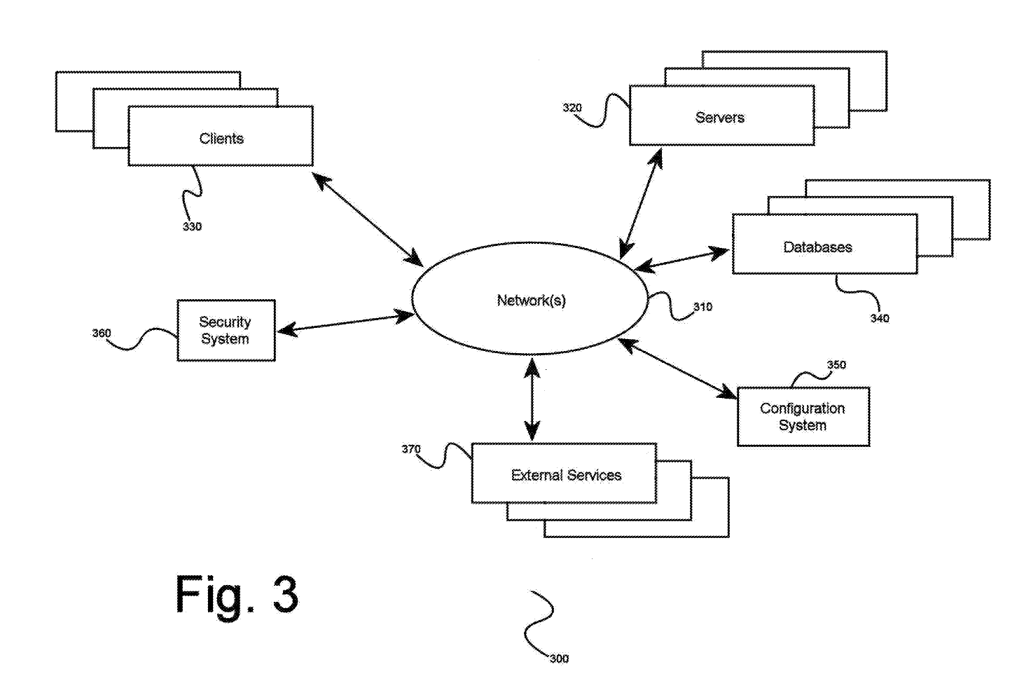

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

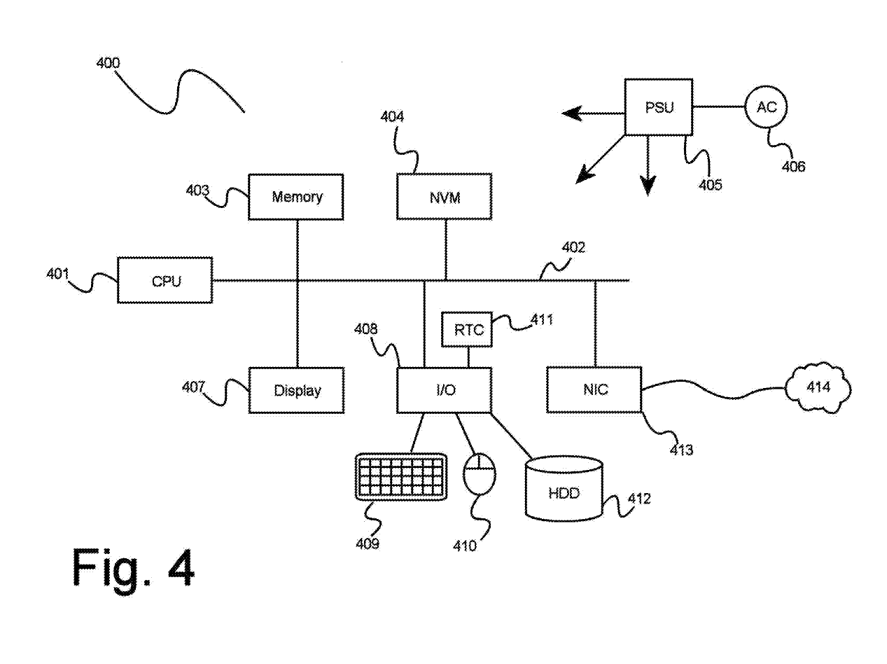

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

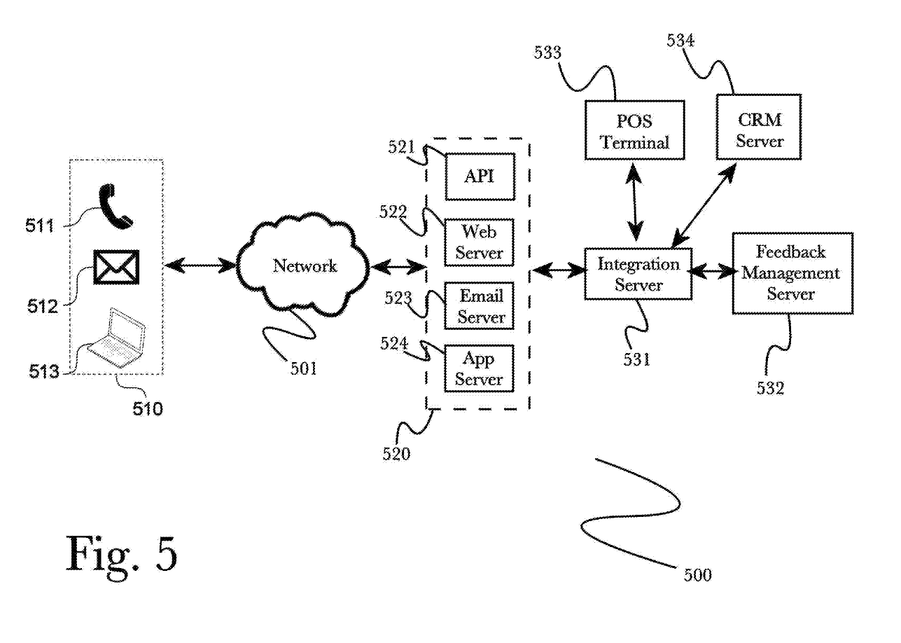

FIG. 5 is a block diagram illustrating an exemplary system 500 for collecting and acting upon user feedback in real-time, according to a preferred embodiment of the invention. According to the embodiment, a plurality of clients 510 may communicate via a network 501, such as the Internet or other data communications network, for example a telephone 511, email client 512, or personal computing device 513. Client 510 may interact with a retail point-of-sale (POS) terminal 533, generally by transmitting and receiving communication in a two-way manner via a plurality of communication adapters 510 operated by an integration server 531, for example using a software application programming interface (API) 521, a web server 522, an email server 523, or an application server 524. For example, an API 521 may be utilized to facilitate two-way communication between a POS terminal 533 and a software application operating on a user's personal computer 513 or mobile device such as a smartphone 511, for example a software application with an integrated “shopping cart” functionality. A web server 522 may be utilized to provide communication between POS terminal 533 and a web browser or similar web-enabled software application operating on their device, such as a personal computer 513 browsing the web via a network 501. An email server 523 may be utilized to communicate with a user for email-based orders as are common in small business operating an online presence, for example without adopting a potentially expensive shopping cart or other software system and instead choosing to utilize a manual or semi-automated checkout system via email messages between a sales associate or administrator and a user communicating via an email client application 512. An application server 524 may be utilized to provide a software application accessible via a network 501 or operating locally on a user's device such as a smartphone 511 or personal computer 513, for example to operate a downloadable app that a user may use to browse a virtual catalog and purchase from. Additionally, users may interact with a POS terminal 533 manually, for example at a retail point of sale when making a purchase in person, such as at a grocer or a physical retail outlet (as opposed to, for example, an online retail outlet or other e-commerce system).

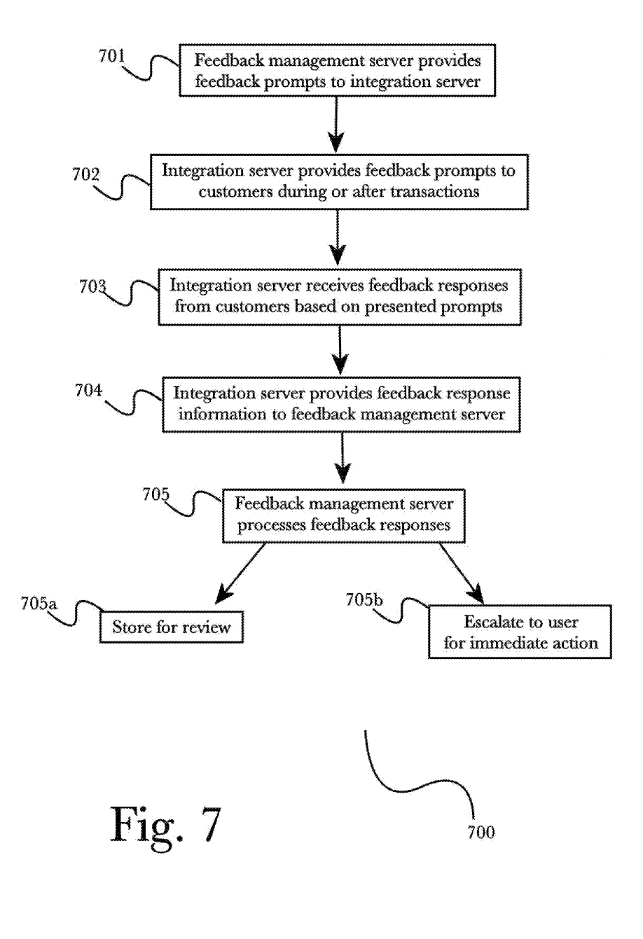

According to the embodiment, a feedback management server 532 may communicate via a network 501, generally via an integration server 531 to utilize one or more of a plurality of communication adapters 510 operated by integration server 531 for a specific use, as described above. According to the embodiment, when a consumer completes a transaction such as a purchase at a POS terminal 533 in person or via a networked means (such as via a software application or email-order system, as described above), feedback management server 532 may provide a plurality of feedback prompts for a consumer to optionally interact with. For example, a customer purchasing an item in person via a retail sales POS terminal 533 may be prompted to enter their telephone number or other contact information, for use in providing a follow-up feedback survey or other contact form at a later time (rather than occupy a large amount of time after a transaction close, which may prevent other customers from completing their transactions and negatively impact retail operation). Another example may be a customer completing a transaction via a software app operating on their smartphone device, and then being prompted to take a brief survey or to provide a “star rating” for their transaction, to provide a business with feedback for the transaction operation or the storefront with which they just interacted (whether virtual or physical). Any responses provided by a customer may be received by the feedback management server 532, and processed accordingly (as described below, referring to FIG. 7), for example to store feedback for use in scoring metrics or to escalate feedback for follow-up by a business associate. For example, when a customer purchases an item in a physical retail location, after checking out via a POS terminal they may be asked to rate their transaction via a relative scoring system such as using “stars” to rate their level of satisfaction with the transaction overall. If a negative or low-rated score is submitted, the feedback may be escalated to a member of management for immediate follow-up before the customer leaves the store, for example to obtain further details from the customer about what specifically they took issue with, or to offer a proactive compensation to encourage them to return despite a single unpleasant transaction (for example, offering a one-time discount on their next purchase to encourage a return visit). In this manner, it may be appreciated that feedback may be both collected and acted upon in real-time, removing any costly delays between a transaction and action in response to the transaction (such as compensating a dissatisfied customer, as described previously).

Further according to the embodiment, feedback may be prompted or received separately from a retail POS terminal 533, for example via a text message sent to a customer's phone 511 or an instant chat prompt opened within an application operating on their personal computer 513, or optionally presented to a cashier rather than a customer (generally so that they may prompt the customer for relevant information as needed). For example, a customer purchasing an item via a software application on a smartphone may receive a text message prompting them to reply with feedback on their transaction (the number may be retrieved from a smartphone's device storage, for example, as contact details are generally readily available on mobile devices and users often opt to provide them on-demand to software applications operating on their device). Or, a customer purchasing an item at a physical retail location may be prompted on a POS terminal to provide a phone number where they may be reached for feedback purposes, for example after the close of a transaction but before a receipt is printed (such an arrangement may ensure the customer does not simply walk away from the terminal, leaving the prompt open for another customer to approach and enter their own information, corrupting the feedback process or potentially posing a privacy risk), and they may then be prompted via a provided number (or email address, instant message account, or other such contact information) to provide feedback on their transaction.

Further according to the embodiment, a feedback management server 532 may automatically act on feedback received, for example by escalating received negative feedback to management for review or action. For example, if a customer is prompted to provide brief feedback using a “star” system, feedback management server 532 may be configured to treat any received feedback of “two stars” or lower to be “negative”, and immediately forward to management staff for action. A manager may then take manual action based on the nature of the feedback, such as by speaking to the customer to resolve a complaint, or providing a courtesy discount or promotion, or other such action. Additionally, certain actions may be configured to be automatically performed by feedback management server 532, such as to apply a courtesy discount or other promotion to a customer's account in a CRM server 534, or to refund a portion of a transaction price, or other such operation. In this manner, feedback may be “actionable” in real-time, either manually by a manager of a retail outlet or automatically by a feedback management server 532 utilized during a shopping process.

Further according to the embodiment, a customer relations managements (CRM) server 534 may be utilized to store and provide customer-related information during operation of system 500. For example, after a transaction in a hospitality setting (such as booking a hotel room, for example), a customer's account information may be provided for use in a feedback prompt (for example, by sending a text message to a phone number known to be associated with the customer, such as one provided during booking). Received feedback may then be associated with a customer, either by storing an association with an existing customer account or by creating a new association based on the transaction reviewed. For example, after purchasing an item at a retail location, a customer may be prompted to provide brief feedback via a POS terminal 533 used to complete the transaction (for example, but handwriting a brief review after signing for the use of a credit card, or by using a PIN pad to select a preconfigured rating or enter their own text or rating), and then the feedback may be stored along with any available customer-specific information such as a provided name or other contact information, form of payment, location (such as by prompting a customer for their ZIP code, or by using location information specific to the retail location itself), or a unique transaction ID, or optionally by randomly-assigning an identifier for future use (for example, to group transactions later or to retrieve a specific transaction by an ID number without necessarily knowing any details of the transaction or customer involved). In this manner, feedback may be linked to specific customers or accounts, enabling the use of analytics to further enhance operation. For example, a particular customer may be known to provide highly-positive reviews, and may be given a special promotion or discount to thank them for their participation in a feedback program. As another example, a particular customer may be identified as having strict expectations of service, and future transactions may be tailored to better suit them and drive feedback in a positive direction.

Further according to the embodiment, transactions or feedback may be immediately viewable by management, for example via a web interface accessible via a web browser software application. Management may review feedback in real-time as it is received and stored, facilitating a live view of their business operation and enabling them to spot any potential problem areas as they appear. For example, a manager may note that a particular POS terminal (such as a cash register at a grocery store, for example) is steadily receiving lower feedback scores as the day progresses. This may be considered a sign that an employee operating the terminal is fatigued or otherwise declining in performance, and a manager may take action such as sending the worker for a break or assigning them to a different task and staffing the POS terminal with a different employee to drive reviews back up. Additionally, such forms of “actionable analysis” may optionally be automated in whole or in part, such as by incorporating automated actions as described above or by automatically updating other business systems such as to update employee schedules automatically in real-time. For example, if a POS terminal is declining in feedback scores, the employee staffing the terminal may be automatically rescheduled for an early lunch break and another employee automatically reassigned to cover their position during the break. As another example, daily feedback scores may be reviewed and employee schedules updated to optimized predicted scores such as by reassigning employees to areas where they have demonstrated exceptional skill, ensuring future feedback remains positive.

### DETAILED DESCRIPTION OF EXEMPLARY EMBODIMENTS

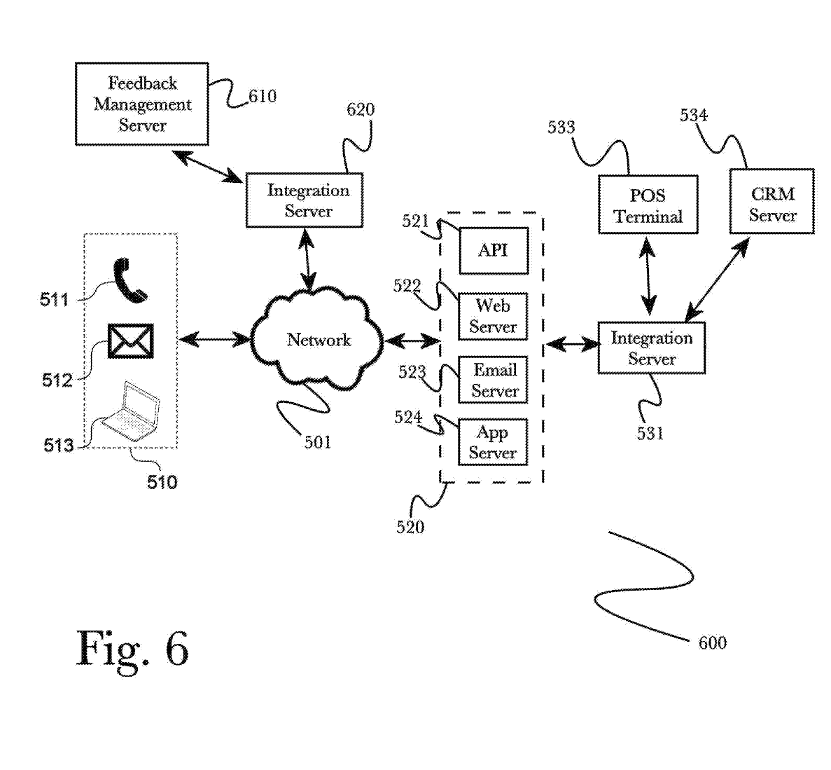

FIG. 6 is a block diagram illustrating an exemplary system 600 for collecting and acting upon user feedback in real-time, utilizing a cloud-based distributed arrangement according to an embodiment. According to the embodiment, a cloud-based integration server 620 may communicate via a network 501, and may facilitate two-way communication between a plurality of business systems such as a POS terminal 533 or CRM server 534 and a cloud-based feedback management server 610, enabling the use of a real-time feedback system via a distributed arrangement such as using a single feedback management server 610 to serve multiple business locations, or multiple separate business entities as clients of a feedback provider. For example, a large business may operate a “feedback center” via network 501, that may operate a feedback management server 610 to provide prompts and receive feedback responses from a number of separate locations such as particular retail outlets or online storefronts. In another example, a feedback management server 610 may be operated by a third-party in a software-as-a-service (SaaS) arrangement, providing the functions of a real-time feedback system as a service so that businesses may choose to subscribe or participate without costly or time-consuming adoption or overhead. In another exemplary arrangement, a business may operate a feedback management server 610 and provide real-time feedback services to small business owners or individuals, for example individuals selling goods using a payment service such as SQUARE™, PAYPAL™ VENMO™ or other such transaction management means. In such an arrangement, a payment service provider or a third party may provide a real-time feedback system for the individual seller, enabling them to collect and act on feedback from their customers and provide a more personalized service to drive their business. In this manner, it may be appreciated that the real-time feedback services provided in the embodiment disclosed herein may be scalable and readily adopted by any seller, regardless of the scale of their business, and it should be further appreciated that the embodiment may be readily employed regardless of the nature of a particular business (such as a physical retail outlet or an online storefront, for example), and that feedback may be provided in a number of ways according to a seller's or customer's preference.

FIG. 7 is a flow diagram illustrating an exemplary method 700 for collecting and acting upon user feedback in real-time, according to a preferred embodiment of the invention. In an initial step 701, a feedback management server may provide a plurality of feedback prompts to an integration server. Prompts may be provided for use at a later time, for example to operate a preconfigured feedback system with pre-programmed prompts for various transaction or customer types. In a next step 702, the integration server may provide a portion of the feedback prompts to a user for interaction according to the nature of the user's transaction, for example using a software “pop-up” menu during an online transaction, or using a text message displayed on a PIN pad or retail POS terminal during checkout. In a next step 703, a user feedback response may be received by the integration server, for example when a user interacts with a presented feedback prompt to submit a review of their transaction. In a next step 704, at least a portion of the received feedback response may be provided to a feedback management server, for example a brief star-based feedback response may be compressed into a simple numerical value for ease of processing or storage or a complex feedback response comprising both text and images may be divided up, the text being provided to one feedback management server and the images provided to another (for example, in an arrangement with multiple feedback management servers performing different functions or handling different types of feedback). In a next step 705, received feedback responses may be processed by a feedback management server, for example to store in a database 705a for future reference (such as for review by a manager to observe or analyze business operations), or to provide to a user 705b immediately, such as to send negative feedback to a manager for immediate review and action.

The skilled person will be aware of a range of possible modifications of the various embodiments described above. Accordingly, the present invention is defined by the claims and their equivalents.

What is claimed is:

1. A system for collecting and acting upon user feedback in real-time, comprising:
a feedback management server comprising at least a plurality of programming instructions stored in a memory and operating on a processor of a computing device and configured to provide at least a plurality of feedback prompts to an integration server, and configured to receive at least a feedback response from an integration server; and
an integration server comprising at least a plurality of programming instructions stored in a memory and operating on a processor of a network-connected computing device and configured to operate a plurality of communication adapters, the configuration adapters each being configured to facilitate two-way communication with a plurality of clients, the clients each comprising at least a network-connected software application or hardware device, and configured to receive at least a plurality of transaction-specific information from at least a portion of the clients, and configured to transmit at least a plurality of feedback requests to at least a portion of the clients, the feedback prompts being based at least in part on at least a portion of the transaction-specific information, and configured to receive at least a plurality of feedback responses from at least a portion of the plurality of clients, and configured to transmit at least a portion of the plurality of feedback responses to a feedback management server.

2. The system of claim 1, wherein the plurality of clients comprise at least a point-of-sale system.

3. The system of claim 2, wherein at least a portion of the plurality of feedback prompts are provided during a point-of-sale transaction.

4. The system of claim 2, wherein at least a portion of the plurality of feedback requests comprise at least a request for additional customer contact information.

5. The system of claim 4, wherein the integration server receives at least a plurality of customer contact information, and transmits at least a feedback prompt to a customer based at least in part on at least a portion of the customer contact information.

6. A method for collecting and acting upon user feedback in real-time, comprising the steps of:
providing, via a feedback management server comprising at least a plurality of programming instructions stored in a memory and operating on a processor of a computing device and configured to provide at least a plurality of feedback requests to an integration server, and configured to receive at least a feedback response from an integration server, a plurality of feedback requests to an integration server;
transmitting, via an integration server comprising at least a plurality of programming instructions stored in a memory and operating on a processor of a network-connected computing device and configured to operate a plurality of communication adapters, the configuration adapters each being configured to facilitate two-way communication with a plurality of clients, the clients each comprising at least a network-connected software application or hardware device, and configured to transmit at least a plurality of feedback requests to at least a portion of the clients, and configured to receive at least a feedback response from at least one of the plurality of clients, and configured to transmit at least the feedback response to a feedback management server, a plurality of feedback requests to a plurality of clients via a network;
receiving at least a plurality of feedback responses from at least a portion of the plurality of clients; and
storing at least a portion of the plurality of feedback responses for future reference.

7. The method of claim 6, further comprising the step of transmitting at least a portion of the feedback responses to a human user for review.
